(19) United States
(12) Patent Application Publication
(10) Pub. No.: US 2013/0275232 A1
(43) Pub. Date: Oct. 17, 2013

(54) METHOD AND APPARATUS FOR PROVIDING SOCIAL INTERACTIVE VIDEO SERVICE

(71) Applicant: KT CORPORATION, Seongnam-city (KR)

(72) Inventors: John OH, Seoul (KR); Hyung-Sik KIM, Seoul (KR); Min-seok KIM, Gwangmyeong-si (KR)

(73) Assignee: KT Corporation, Seongnam-city (KR)

(21) Appl. No.: 13/863,769

(22) Filed: Apr. 16, 2013

(30) Foreign Application Priority Data
Apr. 16, 2012 (KR) 10-2012-0039229

(51) Int. Cl. G06Q 30/02

(52) U.S. Cl. CPC G06Q 30/0273
USPC 705/14.69

(57) ABSTRACT

A method for providing a social interactive video service among users by supporting users accessing a server of a communication system to directly make, edit and share a video containing other content, includes (a) providing, by the server, an interactive video making tool including a video editing interface and a content library having video contents and broadcast contents to a terminal, (b) editing, by the server, a video according to a manipulation of the terminal through the provided interactive video making tool, (c) registering, by the server, the edited video as a video content and sharing the video content, and (d) paying, by the server, an advertising charge to an editor and a provider of an original video content source according to usage information of the shared video content.

### CROSS-REFERENCE TO RELATED APPLICATION

The present application claims priority from Korea Patent Application No. 10-2012-0039229 filed in the Republic of Korea on Apr. 16, 2012, the disclosure of which is hereby incorporated by reference in its entirety.

### BACKGROUND

1. Field

Methods and apparatuses consistent with exemplary embodiments relate to a service which allows a user to directly make, edit and share videos on the Internet, and more particularly, to a service which allows users to interactively share videos and then edit and make a new video by using the shared videos.

2. Background Art

Along with recent rapid development of electronic engineering and communication engineering, a user terminal associated with communication such as a PC, smart phones, notebooks or the like has many more various functions. In other words, along with fast development of wireless/wire communication and data processing techniques, users may use a communication terminal to not only make voice calls but to connect to the Internet, send and receive video calls and video messages. In addition, along with the sudden increase in the supply of communication terminals, a considerable amount of communication is performed through these communication terminals which have made them an essential communication means in modern life.

Due to such development of communication techniques and communication terminals, users may enjoy various types of media such as videos, photographs, music or the like in real time through personal communication terminals. These kinds of video and media streaming service have recently diversified and likewise the number of service users has increased.

Further, instead of the conventional service in which a video or media was unilaterally provided from a service provider in one direction, these days, users can directly make, compose, convert and edit videos and then share the same. For this kind of video sharing service, a user tends to make and edit a video by using his personal computer and then transmits the completed video contents to a video sharing service server for uploading so that the video contents are shared with the public.

In order to use such a service, a video editing and making tool should be installed in a user's personal computer. In addition, in order to insert an advertisement to a video made by a user, broadcast content should be additionally inserted to the made video, which requires double the work. In other cases, a banner advertisement should be separately overlaid on a made video in a video playing (regenerating) unit or an additional advertisement image should be coupled before or after an advertisement, which is called a free roll advertisement. However, such conventional advertising methods are inconvenient.

A system for distributing advertisement revenues obtained by making a video into which an advertisement is inserted and sharing the video is disclosed in Korean Unexamined Patent Publication No. 10-2007-0085423. In the conventional technique disclosed in the document, an advertising apparatus operates on a video content directly made by a user, and advertisement revenues are distributed to a content maker and a content publisher (or a content sharer).

However, this document just suggests an advertisement revenue distributing model between a video maker who has made an image containing an advertisement and a distributor who has shared the video, but does not consider a way to calculate advertisement revenues and a basis for the distribution of the advertisement revenues. In addition, this document does not consider distribution of advertisement revenues to a maker of an original source video which has been used for editing a moving picture, in addition to a video maker and an advertisement distributor.

### SUMMARY

The present disclosure is designed to solve the problems of the prior art, and therefore the present disclosure is directed to providing a service which allows a user to compose, convert and edit a video at a service system, instead of a personal terminal, so that the user may freely and effectively make/edit a video and share the made/edited video.

The present disclosure is also directed to providing a service which allows a user to conveniently insert, convert and compose an advertisement in line with a video when making or editing the video and also allowing a user to insert an advertisement in a desired pattern, not in a uniform way, so that the user may edit a video and insert an advertisement in a more effective and creative way.

Other objects and advantages of the present invention will be understood from the following descriptions and become more apparent from the embodiments of the present invention. Also, it will be understood that the objects and advantages of the present invention can be realized by means defined in the claims of the present invention and a combination thereof. Also, it will be understood that some exemplary embodiments may not solve any of the problems of the conventional art.

In an aspect of the present disclosure, there is provided a method for providing an interactive video service among users, where the users at least one from among directly make, edit and share a video containing other content, the method including: (a) providing, by the server, an interactive video making tool including a video editing interface and a content library having video contents and broadcast contents to a terminal; (b) editing, by the server, a video according to a manipulation of the terminal through the provided interactive video making tool; (c) registering, by the server, the edited video as a video content and sharing the video content; and (d) paying, by the server, an advertising charge to an editor and a provider of an original video content source according to usage information of the shared video content.

The operation (d) may include (d-1) extracting advertisement information from the shared video content; (d-2) calculating the advertising charge according to the extracted advertisement information and usage information of the shared video content; and (d-3) paying the calculated advertising charge to the editor of the shared video content and the provider of the original video content source based on a predetermined ratio.

The advertisement information may include identification information of a broadcast content contained in the shared video content, and advertisement weight information of the identified broadcast content.

The advertisement weight information may be calculated by adding a weight of the identified broadcast content and a weight of exposure time.

The usage information may be information about a playcount of the shared video content during a predetermined time and information about a number of users who have used the shared video content.

In the operation (c), the video content that is edited and registered may be re-used as a video content of the content library.

When the edited and registered video content is re-used as the video content of the content library, an editor of the video content may be classified as the provider of the original video content source.

Before the operation (a), the method may further comprise: registering an original video content uploaded from the terminal, which has been photographed or made by a user, in the content library.

The broadcast contents of the library may be provided from a plurality of advertisers, may be stored and managed by using identification codes corresponding to the plurality of advertisers, and the broadcast contents may have a plurality of patterns, wherein an advertisement weight corresponds to each pattern or each identification code.

The video contents of the library may include information related to the provider of the original video content source.

The interactive video making tool may include at least one from among a video converting region, a video composing region, a sound converting region, a sound composing region, a graphic converting region, a graphic composing region and a mobile interaction region, which allows a user to edit a video.

In the operation (b), the video may be edited at the server according to a manipulation of the terminal, and the video editing interface, the content library and the edited video content are stored and managed by the server

In another aspect of the present disclosure, there is also provided an apparatus for providing an interactive video service among users, where the users at least one from among make, edit and share a video containing other content, the apparatus including: a processor; a memory; an interactive video maker configured to provide to a terminal accessing the apparatus, an interactive video making tool including a video editing interface and a content library having video contents and broadcast contents; a video editor configured to edit a video according to a manipulation of the terminal through the interactive video making tool provided to the terminal; a content sharer configured to register the edited video as a video content and share the video content; and an advertising charge payer configured to pay an advertising charge to an editor and a provider of an original video content source according to usage information of the video content shared through the content sharer. The apparatus may be comprised in a system along with a user terminal.

The advertising charge payer comprises: an advertisement information extractor configured to extract advertisement information from the shared video content; an advertising charge calculator configured to calculate an advertising charge according to usage information including at least one from among an advertisement weight of the extracted advertisement information, information about a playcount of the shared video content, and information about a number of users who have used the shared video content; and an advertising charge payer configured to pay the calculated advertising charge to the editor of the shared video content and the provider of the original video content source used for editing at a predetermined ratio.

In another aspect of the present disclosure, there is also provided a computer-readable recording medium having recorded thereon on a set of instructions related to a method, the computer-readable recording medium being loaded on a server of a communication system for providing an interactive video service among users, where the users at least one from among directly make, edit and share a video containing other content, the method including: providing an interactive video making tool including a video editing interface and a content library having video contents and broadcast contents to a user terminal; editing a video according to a manipulation of the user terminal through the provided interactive video making tool; registering the edited video as a video content and sharing the video content; and paying an advertising charge to an editor and a provider of an original video content source according to usage information of the shared video content.

According to the present disclosure, since a video sharing server system provides a tool for conveniently making and editing a video so that a user may make, edit and share a video at once, the user may conveniently make and edit a video and share the made or edited video instantly in a convenient and efficient way even though a user terminal does not have a video making tool.

In addition, since the server system provides various broadcast contents which may be inserted into videos and allows a user to insert advertisements in a natural and creative way, not in a uniform way, it is possible to eliminate any inconvenience caused by the advertisement and promote advertisement effects more effectively when the video is shared with the public.

### BRIEF DESCRIPTION OF DRAWINGS

Other objects and aspects of the present disclosure will become apparent from the following descriptions of the exemplary embodiments with reference to the accompanying drawings in which:

FIG. 1 is a block diagram showing a system which implements a social interactive video service providing method according to an exemplary embodiment of the present disclosure;

FIG. 2 is a schematic view showing a social interactive video service providing apparatus according to an exemplary embodiment of the present disclosure;

FIG. 3 shows an example of a video editing interface of the social interactive video service providing apparatus according to an exemplary embodiment of the present disclosure;

FIG. 4 is a schematic view showing an example of advertisement information included in a shared video, when the advertisement information is extracted in a social interactive video service providing method according to an embodiment of the present disclosure;

FIG. 5 is a schematic view showing an example of usage information of a shared video, when an advertising charge is calculated in the social interactive video service providing method according to an exemplary embodiment of the present disclosure;

FIG. 6 is a schematic view showing an example of user information included in a shared video, in the social interactive video service providing method according to an exemplary embodiment of the present disclosure;

FIG. 7 is a flowchart for illustrating a social interactive video service providing method according to an exemplary embodiment of the present disclosure; and

FIG. 8 is a flowchart for illustrating processes performed at each node in the social interactive video service providing method according to an exemplary embodiment of the present disclosure.

### DESCRIPTION OF EXEMPLARY EMBODIMENTS

Hereinafter, exemplary embodiments of the present disclosure will be described in detail with reference to the accompanying drawings. Prior to the description, it should be understood that the terms used in the specification and the appended claims should not be construed as limited to general and dictionary meanings, but interpreted based on the meanings and concepts corresponding to technical aspects of the present disclosure on the basis of the principle that the inventor is allowed to define terms appropriately for the best explanation. Therefore, the description proposed herein is just an example for the purpose of illustrations only, not intended to limit the scope of the disclosure, so it should be understood that other equivalents and modifications could be made thereto without departing from the spirit and scope of the disclosure.

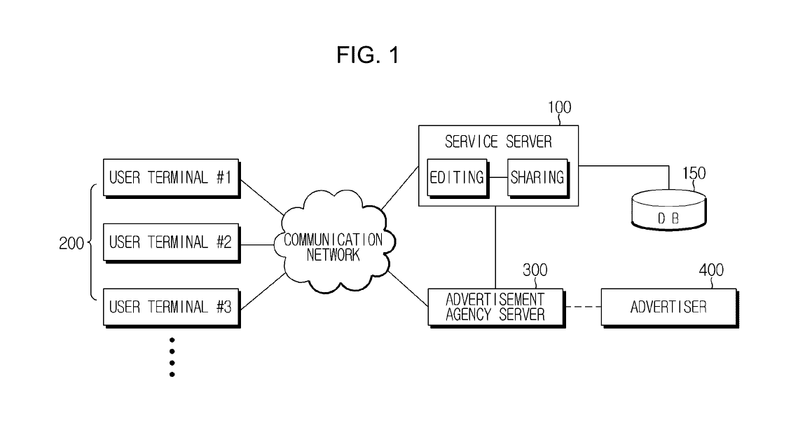

FIG. 1 is a block diagram showing a system which implements a social interactive video service providing method according to an exemplary embodiment of the present disclosure.

Referring to FIG. 1, a system implementing the present disclosure includes user terminals 200 accessing a communication network, a service server 100 for providing social interactive video service to the user terminals, an advertising agency server 300 for providing broadcast contents of the social interactive video service and also providing an advertising charge according to the usage of advertisement, and an advertiser 400 which requests an advertisement through the advertising agency server 300.

First, in the social interactive video service of the present disclosure, a user created content (UCC) is made or edited by a user through the service server 100, instead of the user terminal 200, and the user created content made or edited by the user is posted and shared so as to be used by a plurality of users. By doing so, a user may access the service server 100 and edit and make videos by using a video editing/making tool provided from the server, and simultaneously register and share the made video content. In addition, a shared video content directly made by a user may be reused when the user or another user makes or edits another video, thereby enabling interactive video service among users.

Also, when a user makes or edits a video, a broadcast content may be inserted into or composed with the video, and when the video is shared, an advertising charge according to the contained broadcast content and the shared video is paid. At this time, the advertising charge is calculated according to the degree of regeneration or usage of the contained broadcast content and the shared video and distributed to an editor who has made and edited the shared video and a provider of an original video content source used for making and editing the video.

The service server 100 provides an interactive video editing tool to the user terminals 200 accessed thereto through the communication network, supports users to edit or make videos at the server, and posts and shares the made video contents so as to be played or used by other users. The service server 100 may automatically post and share the made video contents. In other words, the service server 100 provides a video editing service and a video sharing service together to accessed users. The service server 100 includes a database 150 so that a library including various video contents required for editing a video and various broadcast contents may be stored and managed therein. In addition, a video content made, edited and shared by a user is also stored and managed in the database.

In addition, the service server 100 receives broadcast contents through the advertising agency server 300, provides a library to be used for making or editing a video, and obtains an advertising charge according to an advertisement provided through the shared video. The service server 100 according to the present disclosure will be further described in detail later with reference to other drawings.

The user terminal 200 allows a user to access the service server 100 through the communication network in order to make, edit or share a video. In addition, the user terminal 200 may access the service server 100 to receive a shared video content or play contents. The user terminal 200 may use wire/wireless communication terminals such as PC, notebooks, tablet PC, smart phones, PDA or the like, which are accessible to the communication network. Moreover, the communication network may be a wired or wireless communication network, for example the Internet.

The advertising agency server 300 plays a role of paying an advertising charge according to the usage of a broadcast content or an advertisement to the service server 100 in place of a plurality of advertisers 400. The advertising agency server 300 makes contacts with a plurality of advertiser 400 and gives advertises to video service provided through the service server 100. The advertising agency server 300 may receive a broadcast content from the advertiser 400 or directly make a broadcast content in order to provide the broadcast content to the service server 100. In addition, the advertising agency server 300 may be included in the service server 100, and accordingly the advertising agency server 300 may be excluded from the system of the present disclosure. If the advertising agency server 300 is excluded, the service server 100 directly receives broadcast contents and advertising charges from the advertisers 400.

The advertiser 400 provides an advertisement through the advertising agency server 300 or directly to the service server 100 and pays an advertising charge according to the usage of the advertisement.

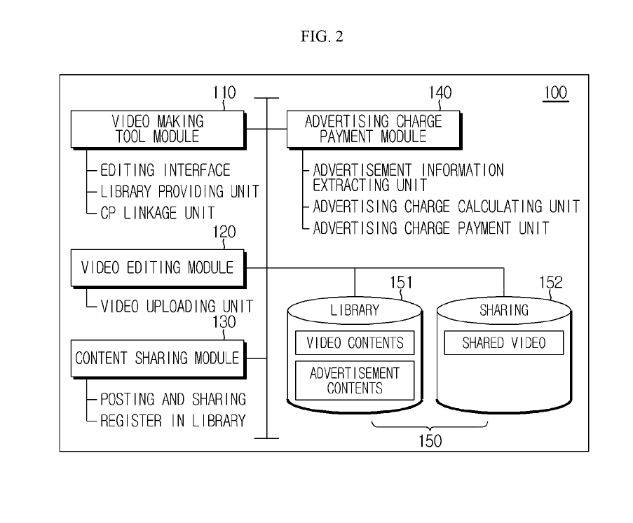

FIG. 2 is a schematic view showing a social interactive video service providing apparatus according to an exemplary embodiment of the present disclosure.

First, the social interactive video service providing apparatus 100 according to the present disclosure is a server for providing video editing service and video sharing service to a plurality of users.

Referring to FIG. 2, the video service providing apparatus 100 according to the present disclosure includes a video making tool module 110, a video editing module 120, a content sharing module 130, an advertising charge payment module 140 and a database 150. A module may be a hardware component, a software component, or a combination of hardware and software. The video service providing apparatus may further comprise a memory 160 and processor 170 for performing the operations and functions that are detailed below. The processor 170 may be specifically programmed to perform the operations and functions of the various modules that comprise the video service providing apparatus.

The video making tool module 110 provides a video making tool to a user terminal accessing the server so that a user directly makes, edits, composes or converts a video. The video making tool module 110 allows users accessing and logging-in the server to make a video at the server, not at user terminals, and a user may easily make or edit videos by using the video making tool provided by the server even though a tool is not separately installed at the user terminal.

The video making tool module 110 includes an editing interface for allowing users to make, edit, compose or convert videos, a library providing unit in which video contents and broadcast contents used for editing videos are stored and provided as a list, a content provider (CP) linkage unit linked to an external content providing server (CP: Content Provider) for allowing contents provided from the outside to be used for editing videos.

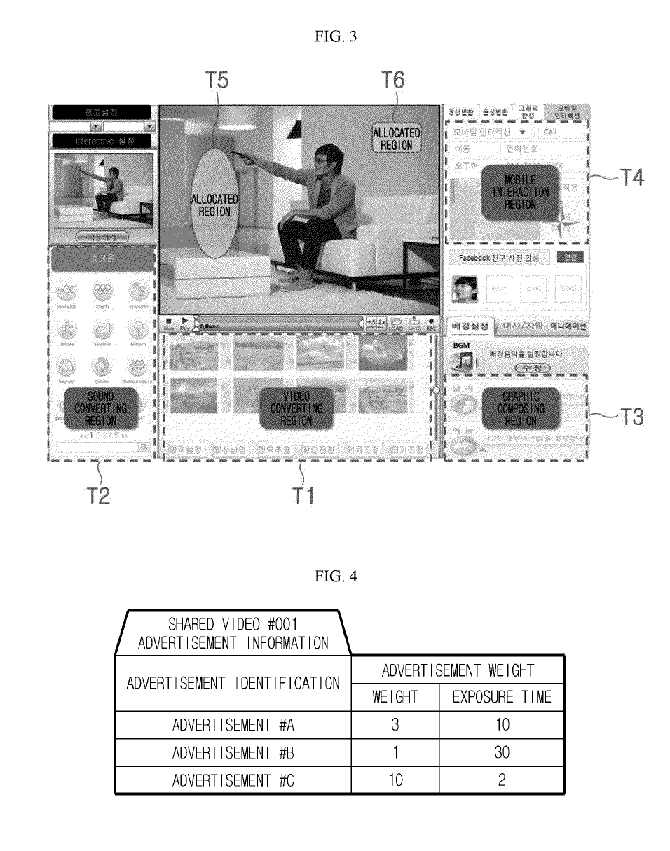

In the video editing interface, as shown in FIG. 3, a screen is divided into several frames, and various editing tools are disposed at the frames. As shown in FIG. 3, a video which is being edited is displayed at a central top region, and a video converting region T1, a sound converting region T2, a graphic composing region T3, a mobile interaction region T4 or the like are arranged around the central top region so as to be conveniently used by a user who makes a video by editing, composing or converting the video.

In addition, the library is provided so that video contents previously prepared, video contents made by other users, and broadcast contents capable of being inserted into or composed with videos may be used. A user may compose a video in a simple way by selecting a desired content from the library, locating the content on a video editing screen and then applying the content thereto. As shown in the figure, the content may be located and applied to regions T5, T6 suitably allocated.

Moreover, the provided broadcast contents include not only simple advertisement images but also props-type contents used in videos, thereby giving a natural advertisement effect. In other words, a function of giving a PPL (Product PLacement) advertisement effect is included.

Further, a broadcast content inserted into or composed with a video occupies a separate region of the video. In this case, if a user who is watching the video clicks the broadcast content, click information is provided or the click is linked to a designated webpage to provide product information or advertisement information or give a pop-up window containing product information. At this time, if the advertisement region is clicked, the played video is stopped, and then an Internet browser (e.g., Internet Explorer, Safari, Chrome, Firefox or the like) is executed to link the designated corresponding webpage and provide an information screen. In addition, the number of clicks on the broadcast content and the log information about links to the webpage may be collected and provided to the advertising agency server 300 or the advertiser 400 which has provided the corresponding broadcast content. At this time, the log information may include information about broadcast content consumption of users, and this consumption information may include loading time, inflow paths, usage of detail pages, purchase information or the like.

Here, the interface screen shown in the figure is just an example of the present disclosure, and various editing tools and other tools as well frame designs may be arranged and designed in various ways. Therefore, the present disclosure is not limited to the interface depicted in the figure.

In addition, the video converting region T1 of the video editing interface may include an auto chroma key engine capable of changing a background as desired, a social networking service application programming interface (SNS API) content converting engine capable of composing a photograph of a social friend, a region tracking engine exhibiting the user as a main character, or the like.

The sound converting region T2 may include an audio composing engine capable of inserting a voice, a BGM/sound effect/narration function for inserting various sound effects, an audio segmentation engine converting by a voice command, or the like.

The graphic composing region T3 may include a real-time video analyzing engine for changing a video according to time, weather and environment around the user, a motion graphic composing engine allowing a character to fly, an overlay analyzing engine allowing a product shown in an image to be directly purchased, or the like.

The mobile interaction region T4 may include a mobile interactive message/call function allowing an object in the image to directly send a call or message, a location-based customized advertisement function capable of containing information about neighboring stores, or the like.

The above tools are just examples, and various tools for editing, converting or processing videos may also be used other than the above.

The library providing unit of the video making tool module 110 provides a list of video contents and broadcast contents, registered in a database (described later), so that a user may select and use a desired content. The user may apply various video and media contents, provided through the library providing unit, to a video, made or edited by the user, in various ways.

In addition, the CP linkage unit may link to an external content provider so that various external contents may be applied to the video made or edited by the user. By doing so, an interactive video may be made.

The video editing module 120 edits a video edited by the user through the video making tool module 110. In other words, the user accesses the server by using the user terminal and edits a video by using the video editing tool provided from the server, and accordingly the video editing module 120 of the server edits, composes or converts the video. In addition, the video editing module 120 includes a video uploading unit so that a video directly recorded by the user or a video stored in the user terminal may be uploaded and registered in the library. By doing so, the user may upload a video separately recorded or made by the user to the server to be registered in the library, and then use the corresponding video content for editing another video.

The content sharing module 130 stores the video completely processed by the video editing module 120 in the database 150, described later, as a video content, and then posts the video content on the website so as to be shared with other users. The content sharing module 130 briefly performs a posting and sharing process and a library registration process. In the posting and sharing process, video contents registered in the database 150 are posted and shared with users. In the library registration process, videos made or edited by users through the service of the present disclosure are stored in the database and registered in the library.

The completely edited video contents are posted on the website and shared with other users, and they are also registered in the library and used when other users edit videos. At this time, if the shared video content is registered in the library and used when another user edits a video, an editor of the shared image is identified as a provider of an original video content source. By doing so, when an advertising charge is calculated and distributed, the editor of the video content registered in the library may receive an advertising charge corresponding to the provider of the original video content source.

When the server provides the service of the present disclosure, the advertising charge payment module 140 calculates an advertising charge according to the usage of an advertisement contained in the shared video, and pays the calculated advertising charge to an editor of the corresponding shared video and a provider of an original video content source. For this, the advertising charge payment module 140 calculates advertising charges according to the usage of advertisements at predetermined time intervals with respect to video contents shared through the content sharing module 130, determines targets to receive the advertising charges, and pays the advertising charges according to a predetermine ratio. The advertising charge payment module 140 may include an advertisement information extracting unit, an advertising charge calculating unit, an advertising charge payment unit or the like.

The advertisement information extracting unit extracts advertisement information included in videos shared through the content sharing module 130. In addition, whenever a predetermined time passes, the advertisement information extracting unit extracts advertisement information for calculating and paying advertising charges. For example, the predetermined time may be one month or one week. In other words, once a month or a week, advertisement information of shared videos are calculated to calculate and pay advertising charges.

The advertisement information extracted by the advertisement information extracting unit may include advertisement identification information contained in shared video contents and advertisement weight information of identified broadcast contents. In other words, the information indicating which broadcast content is inserted in the shared video content, how much the inserted broadcast content is exposed, how much weight the advertisement weight set in the advertisement has, or the like, is included. In addition, a plurality of inserted broadcast contents may be present. For this, an advertiser and the kind of each inserted broadcast content are distinguished according to the identification information.

FIG. 4 is a schematic view showing an example of advertisement information included in a shared video, when the advertisement information is extracted in the social interactive video service providing method according to an exemplary embodiment of the present disclosure.

As shown in FIG. 4, from the advertisement information included in a shared video #001, identification information of an advertisement contained in the corresponding video #001 and weight information of the identified broadcast content are extracted separately. The extracted advertisement identification information has three kinds of advertisement #A, advertisement #B and advertisement #C, as shown in the figure, and each extracted broadcast content contains weight information and exposure time information about each advertisement. The weight information is set when the broadcast content is initially provided, and the exposure time information is counted when the content sharing module 130 shares a video. Referring to the example depicted in the figure, advertisement information having a weight of 3 and an exposure time of 10 is extracted from the advertisement #A, advertisement information having a weight of 1 and an exposure time of 30 is extracted from the advertisement #B, and advertisement information having a weight of 10 and an exposure time of 2 is extracted from the advertisement #C.

The advertising charge calculating unit calculates an advertising charge according to the advertisement information extracted by the advertisement information extracting unit and the usage information of the corresponding shared video. The usage information of the video content represents how much the corresponding video that has been posted and shared, is played and used by other users. For example, the number of users who have read or played the shared video or the count of playing the shared video may be the usage information. The advertising charge calculating unit calculates an advertising charge proportional to the usage information of the shared video with respect to the extracted advertisement information. In other words, a final advertising charge may be calculated by multiplying the advertising charge according to the advertisement contained in the video and its weight by a ratio according to the advertisement usage information.

FIG. 5 is a schematic view showing an example of usage information of a shared video, when an advertising charge is calculated in the social interactive video service providing method according to an exemplary embodiment of the present disclosure.

As shown in FIG. 5, the usage information of the shared video #001 may be exhibited as the playcount information and the number of users, separately. In other words, referring to the example depicted in the figure, the playcount of the corresponding video is recorded as 370,000, and the number of users of the corresponding video is recorded as 100,000. In other words, the playcount may be obtained by recording the number of times the corresponding shared video is played, regardless of users, and the number of users is recorded by counting every user who has used the corresponding shared video at least once. Therefore, the recorded playcount may be greater than the recorded number of users.

Referring to the example depicted in FIG. 4, before the advertisement usage information is applied, the advertising charge is calculated as follows. For example, with respect to the advertisement #A, an advertising charge is calculated as 30 by multiplying a weight of 3 by an exposure time of 10. With respect to the advertisement #B, an advertising charge is calculated as 30 by multiplying a weight of 1 by an exposure time of 30. With respect to the advertisement #C, an advertising charge is calculated as 20 by multiplying a weight of 10 by an exposure time of 2. Therefore, if the above values are added up, the advertising charge is calculated as 80.

Here, a final advertising charge for the corresponding shared video during a predetermined period is calculated by applying a ratio according to the usage information of the corresponding shared video in FIG. 5.

The advertising charge payment unit distributes and pays the advertising charge calculated by the advertising charge calculating unit to an editor of the shared video and a provider of an original video content used for editing or making the corresponding shared video according to predetermined ratios. For this, the advertising charge payment unit extracts or figures out the identification information of the user who has edited the shared video or the identification information of the provider of the original video content source used for the shared video. In addition, the ratios of the advertising charge distributed to the editor and the source provider may be set by an operator of the service server, and the source provider may include one or more user.

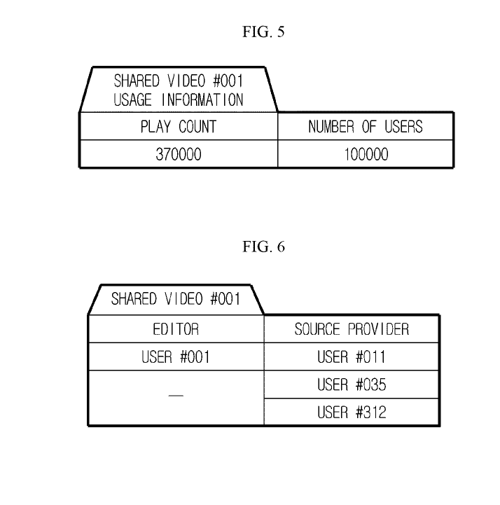

FIG. 6 is a schematic view showing an example of user information included in a shared video, in the social interactive video service providing method according to an exemplary embodiment of the present disclosure.

As shown in FIG. 6, the shared video #001 includes identification information of an editor who has finally edited the corresponding video and identification information of a provider of a source used for editing the corresponding shared video. Referring to an example depicted in the figure, an editor of the shared video #001 is a user #001, and a provider of the source video used for editing the shared video #001 includes three users, namely a user #011, a user #035 and a user #312. In other words, in this example, it may be understood that the shared video has been edited and made by one editor, and source videos provided by three source providers have been used for editing the corresponding shared video. Based on the information of the editor and the information of the source provider, the finally calculated advertising charge may be distributed to each editor and each source provider.

The database 150 may be divided into a library database 151 and a sharing database 152. Here, the library database 151 stores and manages video contents and broadcast contents which may be used by users for editing videos. In addition, the sharing database 152 stores and manages video contents which have been completely edited and posted on the website so as to be shared. At this time, the video contents stored in the sharing database 152 may be automatically registered as video contents of the library database 151.

In addition, the library database 151 stores and manages broadcast contents provided from advertisers or advertising agency servers. The broadcast content is endowed with an identification code for distinguishing its advertiser and pattern. By doing so, if the corresponding broadcast content is extracted, it is possible to identify an advertiser, pattern and kind of the corresponding broadcast content. In addition, the identification code of the broadcast content may include advertisement weight information, and the advertisement weight information stores advertisement weight information of the broadcast content set by the advertiser or the advertising agency server. The advertisement weight information is suitably set according to importance or utilization of the corresponding advertisement.

Along with it, the video content stored in the library database 151 includes information about the provider of the original video content source used for editing the corresponding video content, and this information is utilized when an advertising charge is distributed to the source provider later.

Hereinafter, a social interactive video service providing method according to an embodiment of the present disclosure will be described in detail.

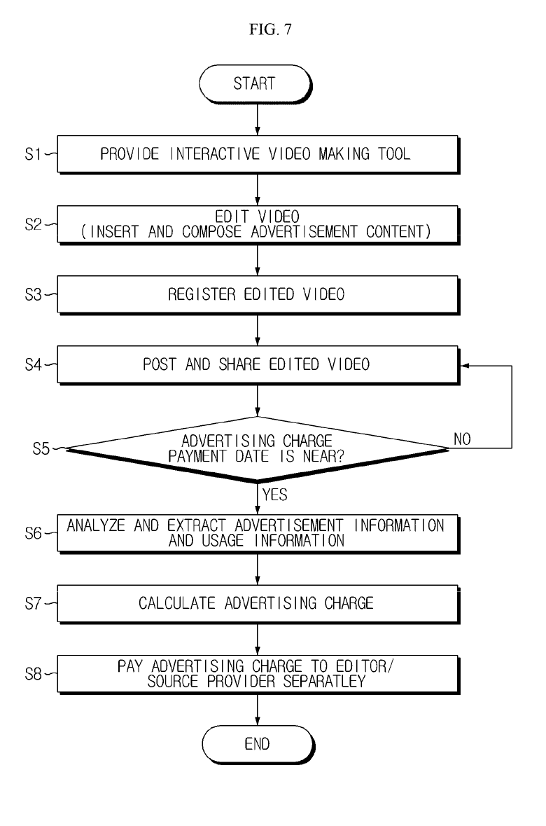

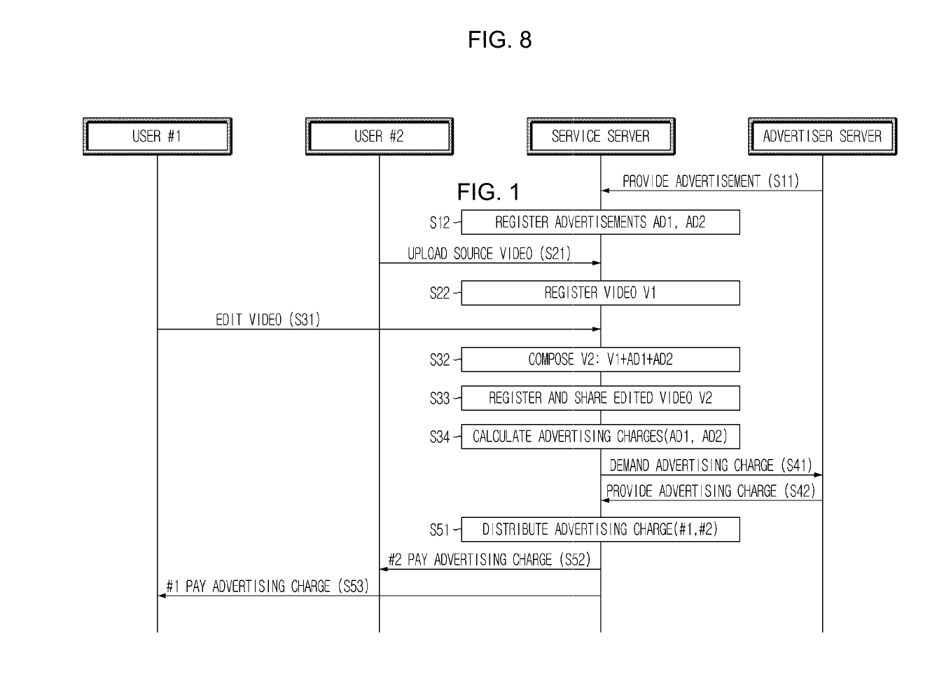

FIG. 7 is a flowchart for illustrating a social interactive video service providing method according to an exemplary embodiment of the present disclosure.

Referring to FIG. 7, first, an interactive video making tool is provided so as to give video editing service to a user accessing the video service providing server through a user terminal. At this time, the user accesses the server through the user terminal and is provided with the video editing tool. Therefore, it is not needed to install separate video editing software in the user terminal, and the user terminal need not have such separate video editing software. In addition, the video editing process is performed at the server, not at the user terminal Therefore, no burden is added to the user terminal (S1).

Next, the user edits a video by using the provided interactive video editing tool. At this time, the user may suitably select a video content and a broadcast content as desired from the library provided together with the tool, and then insert the content into the video to be edited or compose or convert the video by using the content (S2).

If the video is completely edited, the server registers the edited video as a video content. Here, the edited video content may be stored in the library database and the sharing database so as to be reused as an original source when another video is edited (S3).

Next, the server posts the edited and registered video on the website to be shared with other users. The server checks and records the count of playing the corresponding video by other uses and the number of users who have used the corresponding video. Thus, data will be used later for calculating an advertising charge (S4).

After the video is posted and shared, it is determined whether a given payment date for the advertising charge is near. In other words, at regular periods, advertising charges for shared videos are calculated and paid, and in this process, it is determined whether a deadline of the given period is near. The advertising charge payment data may be determined as the last day of every month, every Saturday or the like. If the advertising charge payment date is not near, the video keeps being posted and shared. If the advertising charge payment data is near, the following process is executed (S5).

If it is checked that the advertising charge payment data is near, the server analyzes and extracts advertisement information and usage information of shared videos in order to calculate and pay advertising charges. At this time, the advertisement information is extracted from identification information of an advertisement contained in each shared video, and the usage information of the shared video recorded when the video is posted and shared is extracted (S6).

If the advertisement information and the usage information are extracted, an advertising charge for the corresponding shared video is calculated based on the above information. The advertising charge calculating process is already described in detail above and not described again here (S7).

If the advertising charge is calculated, the server divides and pays the calculated advertising charge to an editor of the corresponding shared video and a provider of a source video used for editing the corresponding shared video at predetermined ratios (S8).

By doing so, the social interactive video service is completely provided. In this way, users may access the server, directly make or edit videos, and instantly post and share the edited video at the same server, thereby interactively and conveniently producing and consuming UCC. In addition, an advertising charge is calculated for each video shared for a given period, and the advertising charge is paid to a video editor and a source provider respectively to return the profit to the users, thereby attracting more users.

FIG. 8 is a flowchart for illustrating processes performed at each node in the social interactive video service providing method according to an exemplary embodiment of the present disclosure.

Referring to FIG. 8, processes for registering an advertisement and a source video, editing and sharing a video by using the advertisement and the source video, and accordingly paying an advertising charge according to the social interactive video service providing method of the present disclosure will be described (S11).

First, the advertiser server or advertising agency server provides a broadcast content to the social interactive video service server for advertisement (S12).

The service server stores and registers the broadcast content provided from the advertiser server in the library of the database. As shown in FIG. 8, the advertiser server provides broadcast contents AD1, AD2, and the service server registers the broadcast contents AD1, AD2 (S21).

Next, a user #2 accesses the service server and uploads a video content personally photographed or made. At this time, the user #2 accessing the server does not edit or make a video through the server but uploads the video content personally made to request sharing service (S22).

The service server stores and registers the video content V1 uploaded by the user #2 in the sharing database and the library database, respectively. The video content V1 registered in the sharing database is posted on the website so as to be shared with other users, and the video content V1 stored in the library database is used as a video content library which may be used when other users edit videos (S31).

The user #1 accesses the service server and requests the video making tool provided from the service server for editing a video (S31).

According to the request of the user #1, the service server edits the video V2, and at this time the user uses the video V1 registered in the library database and inserts or compose the advertisements AD1, AD2 into the video in order to edit the video (S32).

If the video V2 is completely edited, the service server stores and registers the edited video V2 in the library database and the sharing database, respectively, and posts the registered video V2 on the website so as to be read or played by other users. In addition, the video V2 registered in the library database is also utilized as video content which may be used when other users edit videos (S33).

If a predetermined period is near, the service server calculates an advertising charge for the shared video V2. At this time, the broadcast contents AD1, AD2 contained in the video V2 are extracted, and a final advertising charge is calculated by using the advertisement weight information of each broadcast content and the usage information of the shared video (S34).

If the service server calculates the advertising charge, an advertising charge is demanded from the advertiser server who has requested advertisement of the broadcast contents AD1, AD2 contained in the shared video (S41).

The advertiser server checks the demanded advertising charge and then pays the demanded advertising charge to the service server (S42).

The service server distributes the advertising charge provided from the advertiser server to the editor (the user #1) of the shared video (V2) and the source provider (the user #2). At this time, the shared video is analyzed to figure out the editor of the shared video and the provider of the source video used for editing the shared video (there may be a plurality of providers), and then the advertising charge is allocated to the corresponding editor and source provider at predetermined ratios (S51).

The service server pays the allocated advertising charge to the editor (the user #1) and the source provider (the user #2), respectively (S52,S53).

In addition, if the video edited by the user #1 is used by another user who edits another video, the user #1 is classified as a source provider and receives an advertising charge provided to a source provider. By doing so, a user may make an advertisement profile by sharing a video made by the user, and may also make an additional advertisement profile when the video is used by another user who edits another video. Therefore, the present disclosure may lead to more active content production and also promote advertisement effects more effectively.

The method of the present disclosure described above may be implemented as a program and may be stored in a recording medium (CD-ROM, RAM, ROM, floppy disc, hard disc, magneto-optical disc or the like) in a computer-readable form.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination.

Although the drawings describe the operations in a specific order, one should not interpret that the operations are performed in a specific order as shown in the drawings or successively performed in a continuous order, or all the operations are performed to obtain a desired result. Multitasking or parallel processing may be advantageous under any environment. Also, it should be understood that all exemplary embodiments do not require the distinction of various system components made in this description. The program components and systems may be generally implemented as a single software product or multiple software product packages.

Various substitutions, changes and modifications can be made to the present disclosure described above by those having ordinary skill in the art within the scope of the present disclosure and the present disclosure is not limited to the above exemplary embodiments and the accompanying drawings.

1. A method for providing an interactive video service among users, where the users at least one from among make, edit and share a video containing other content, the method comprising:
(a) providing, by the server, an interactive video making tool including a video editing interface and a content library having video contents and broadcast contents to a terminal;
(b) editing, by the server, a video according to a manipulation of the terminal through the provided interactive video making tool;
(c) registering, by the server, the edited video as a video content and sharing the video content; and
(d) paying, by the server, an advertising charge to an editor and a provider of an original video content source according to usage information of the shared video content.

2. The method according to claim 1, wherein the operation (d) comprises:
(d-1) extracting advertisement information from the shared video content;
(d-2) calculating the advertising charge according to the extracted advertisement information and usage information of the shared video content; and
(d-3) paying the calculated advertising charge to the editor of the shared video content and the provider of the original video content source based on a predetermined ratio.

3. The method according to claim 2, wherein the advertisement information includes identification information of a broadcast content contained in the shared video content, and advertisement weight information of the identified broadcast content.

4. The method according to claim 3, wherein the advertisement weight information is calculated by adding a weight of the identified broadcast content and a weight of exposure time.

5. The method according to claim 1, wherein the usage information is information about a playcount of the shared video content during a predetermined time and information about a number of users who have used the shared video content.

6. The method according to claim 1, wherein, in the operation (c), the video content that is edited and registered is re-used as a video content of the content library.

7. The method according to claim 6, wherein when the edited and registered video content is re-used as the video content of the content library again, an editor of the video content is classified as the provider of the original video content source.

8. The method according to claim 1, before the operation (a), further comprising:
registering an original video content uploaded from the terminal, which has been photographed or made by a user, in the content library.

9. The method according to claim 1, wherein the broadcast contents of the library are provided from a plurality of advertisers, are stored and managed by using identification codes corresponding to the plurality of advertisers, and the broadcast contents have a plurality of patterns, wherein an advertisement weight corresponds to each pattern or each identification code.

10. The method according to claim 1, wherein the video contents of the library include information related to the provider of the original video content source.

11. The method according to claim 1, wherein the interactive video making tool comprises at least one from among a video converting region, a video composing region, a sound converting region, a sound composing region, a graphic converting region, a graphic composing region and a mobile interaction region, which allows a user to edit a video.

12. The method according to claim 1, wherein, in the operation (b), the video is edited at the server according to a manipulation of the terminal, and the video editing interface, the content library and the edited video content are stored and managed by the server.

13. An apparatus for providing an interactive video service among users, where the users at least one from among make, edit and share a video containing other content, the apparatus comprising:
a processor;
a memory;
an interactive video maker configured to provide to a terminal accessing the apparatus, an interactive video making tool including a video editing interface and a content library having video contents and broadcast contents;
a video editor configured to edit a video according to a manipulation of the terminal through the interactive video making tool provided to the terminal;
a content sharer configured to register the edited video as a video content and share the video content; and
an advertising charge payer configured to pay an advertising charge to an editor and a provider of an original video content source according to usage information of the video content shared through the content sharer.

14. The apparatus according to claim 13, wherein the advertising charge payer comprises:
an advertisement information extractor configured to extract advertisement information from the shared video content;
an advertising charge calculator configured to calculate an advertising charge according to usage information including at least one from among an advertisement weight of the extracted advertisement information, information about a playcount of the shared video content, and information about a number of users who have used the shared video content; and
an advertising charge payer configured to pay the calculated advertising charge to the editor of the shared video content and the provider of the original video content source used for editing at a predetermined ratio.

15. A computer-readable recording medium having recorded thereon a set of instructions related to a method, the computer-readable recording medium being loaded on a server of a communication system for providing an interactive video service among users, where the users at least one from among make, edit and share a video containing other content, the method comprising:
providing an interactive video making tool including a video editing interface and a content library having video contents and broadcast contents to a user terminal;
editing a video according to a manipulation of the user terminal through the provided interactive video making tool;
registering the edited video as a video content and sharing the video content; and
paying an advertising charge to an editor and a provider of an original video content source according to usage information of the shared video content.

16. The method according to claim 1, wherein the terminal is a user terminal and, in operation (c), the video content is shared with users by posting the video content on a website.

17. The apparatus according to claim 13, wherein the video content is shared with users by posting the video content on a website.

18. The computer-readable recording medium according to claim 15, wherein the video content is shared with users by posting the video content on a website.

19. The method according to claim 4, wherein the advertisement weight information is set when the broadcast content is initially provided, and the exposure time is counted when the video content is shared.

20. The method according to claim 1, wherein the terminal does not perform editing of the video.

21. The apparatus according to claim 13, wherein the terminal does not edit the video.

22. The computer-readable recording medium according to claim 15, wherein the terminal does not edit the video.

23. A system comprising:
an apparatus for providing an interactive video service among users to a user terminal, where the users at least one from among make, edit and share a video containing other content; and
the user terminal,
wherein the apparatus comprises:
a processor;
a memory;
an interactive video maker configured to provide to the user terminal accessing the apparatus, an interactive video making tool including a video editing interface and a content library having video contents and broadcast contents;
a video editor configured to edit a video according to a manipulation of the user terminal through the interactive video making tool provided to the user terminal;
a content sharer configured to register the edited video as a video content and share the video content; and
an advertising charge payer configured to pay an advertising charge to an editor and a provider of an original video content source according to usage information of the video content shared through the content sharer.
